(19) United States
(12) Patent Application Publication
(10) Pub. No.: US 2015/0368955 A1
(43) Pub. Date: Dec. 24, 2015

(54) Reinforced Window Profile

(71) Applicant: ROYAL GROUP, INC., Vaughn (CA)

(72) Inventors: Avi ZOHAR, York Regional Municipality (CA); John TODD, Toronto (CA); Andrew DUDLEY, Abingdon, VA (US); Ashishkumar GANDHI, Peel Regional Municipality (CA); Domenic COMMISSO, York Regional Municipality (CA); Steve CHANDLER, Toronto (CA)

(21) Appl. No.: 14/742,084

(22) Filed: Jun. 17, 2015

Related U.S. Application Data
(60) Provisional application No. 62/015,039, filed on Jun. 20, 2014.

(51) Int. Cl. E06B 3/20; E06B 3/12; B29C 47/02

(52) U.S. Cl. CPC E06B 3/205; B29C 47/027; E06B 3/12; B29K 2027/06

(57) ABSTRACT

An extruded window profile includes metal inserts bound within and along the length of the profile through coextrusion of the profile and inserts through an extrusion die.

### CROSS-REFERENCE TO RELATED APPLICATIONS

The present application claims priority to U.S. Provisional Application No. 62/015,039 filed Jun. 20, 2014, the contents of which are incorporated herein by reference in their entirety.

### BACKGROUND OF THE INVENTION

The current industry practice in the field of window profile reinforcing inserts is to insert a separate metal shape inside the hollow polyvinylchloride (PVC extrusion) during the assembly process of the window. Specifically, a window profile is first extruded to include a hollow area and then a desired metal insert is assembled into the hollow area. One disadvantage of the current practice is that separate profile extrusion and insert assembly requires multiple manufacturing steps.

### SUMMARY OF THE INVENTION

In embodiment of the present invention, the need for additional manufacturing steps is avoided by providing simultaneous and continuous-line insertion of metal inserts, including aluminum inserts, into a window profile during the extrusion process.

Embodiments of the invention include inserting aluminum reinforcing strips into vinyl window profiles, including PVC window profiles, with use of heat activated adhesive. Strips are inserted and fed through desired slots in an extrusion die during the PVC window profile extrusion process and are integrated in the window profile at the desired locations where the slots are present.

An advantage of embodiments of the invention includes increasing the strength of a PVC window extrusion as metal, such as aluminum , is stronger than PVC alone or fiberglass reinforced vinyl profiles.

Another advantage of embodiments of the invention is avoiding additional manufacturing steps as convention window manufacturer currently insert a separate aluminum extrusion inside a PVC extrusion that is separately created.

Another advantage of embodiments of the invention is that aluminum, particularly aluminum pre-coated with a heat-activated adhesive in some embodiments, inserted during the PVC profile extrusion process helps control thermal expansion/contraction of PVC.

Other advantages of embodiments of the invention include that multiple inserts, such as aluminum strips, can be inserted simultaneously at several desired locations in a profile to provide specific reinforcement characteristics to the profile while avoiding multiple manufacturing steps and assembly that would be required with traditional post-extrusion insertion methods.

### BRIEF DESCRIPTION OF THE DRAWINGS

FIG. 1 is a top plan cross-sectional view of a PVC window extrusion profile with inserted metal reinforcing inserts in one embodiment of the invention.

FIG. 2 is a partial, cross-sectional perspective view of a PVC window extrusion profile showing an isolated extended view of inserted metal reinforcing inserts in one embodiment of the invention.

FIG. 3 is a front perspective view of an extrusion die for a window extrusion profile including front slots for passage of metal reinforcing inserts through the die with the extrusion in one embodiment of the invention.

FIG. 4 is a rear perspective view of an extrusion die for a window extrusion profile including rear slots for passage of metal reinforcing inserts through the die with the extrusion in one embodiment of the invention.

FIG. 5 is a schematic top plan view of prior art window frame including reinforcement strips with straight cuts short of the frame corners.

FIG. 6 is a schematic top plan view of a window frame including reinforcement strips extending to frame corners in one embodiment of the invention.

### DETAILED DESCRIPTION OF THE INVENTION

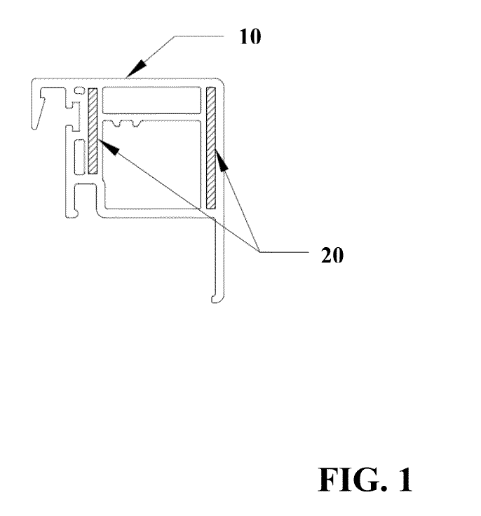

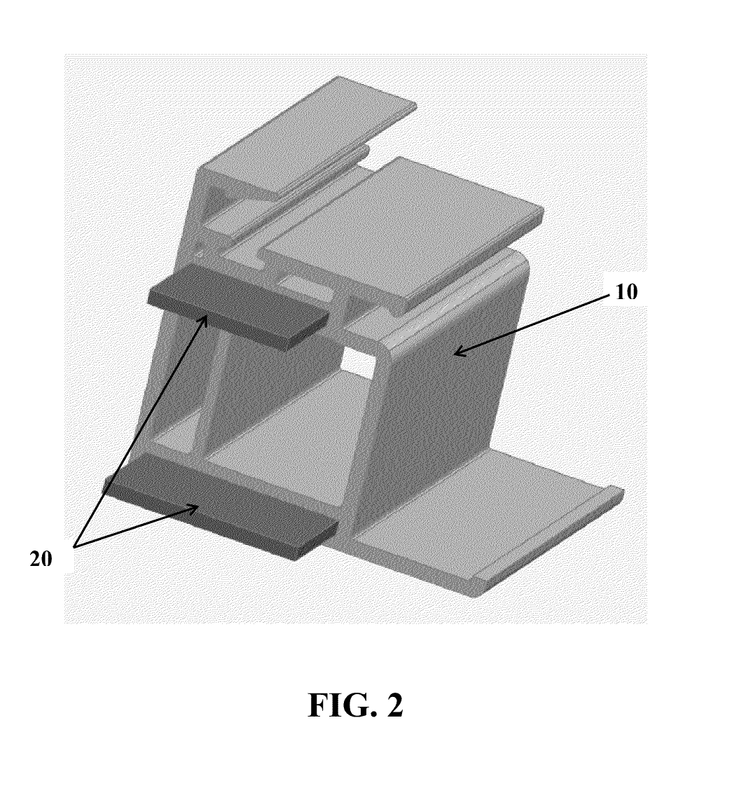

Referring to FIGS. 1 and 2, the present invention is directed to an extruded window profile 10, preferably a PVC profile, including integral metal inserts 20, preferably aluminum flat strips. It will be appreciated that a window profile of the invention may include one or more inserts 20, and in preferred embodiments includes a plurality of inserts 20 at multiple locations in the profile to provide desirable reinforcing characteristics to the extrude profile 10. It will also be appreciated that profile 10 may be shaped as desired, and is not limited to the shape and configuration, or placement of the inserts 20, shown in the disclosed embodiments.

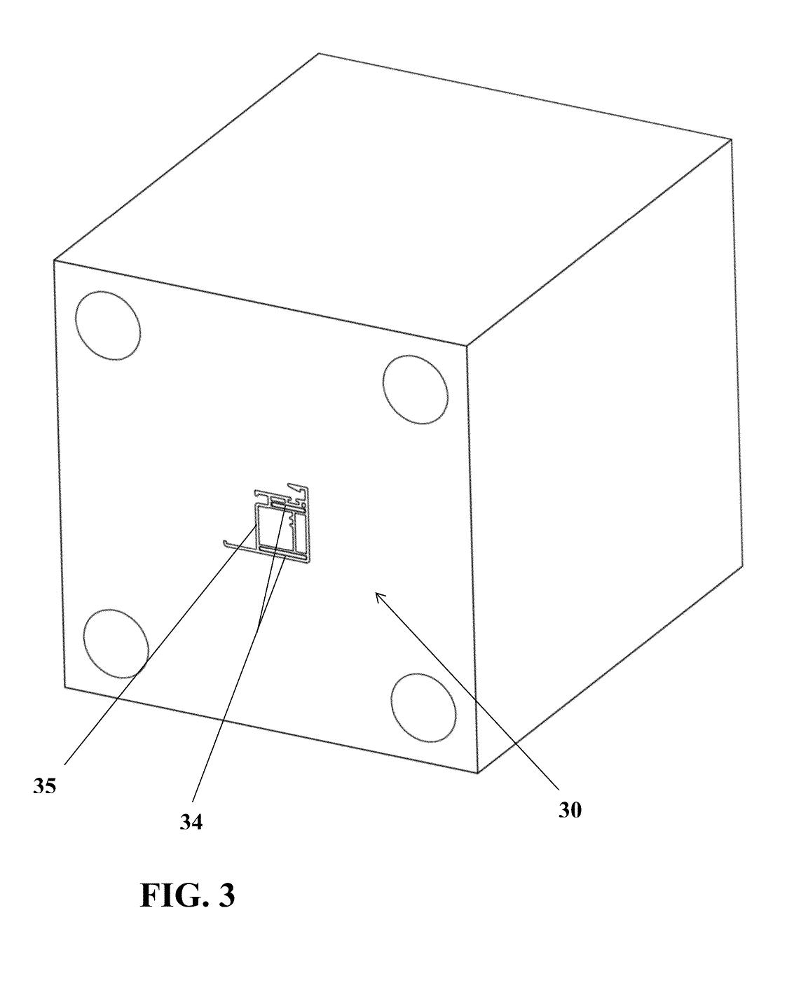

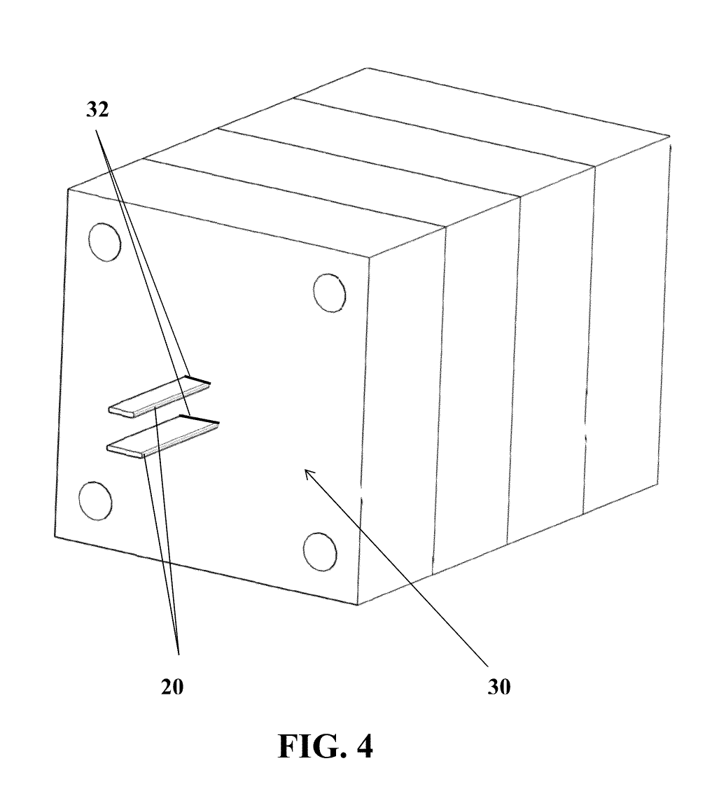

Referring to FIGS. 3 and 4, in one embodiment of the invention, multiple metal inserts 20 are fed through rear insert slots 32 in an extrusion die 30. In an embodiment of the invention, the inserts 20 are flat aluminum strips that are fed from coils of aluminum. In some embodiments the inserts 20 are passed through the die through the rear insert slots 32 and then through the front insert slots 34. In embodiments, the ends of the inserts opposite the coiled ends may be coupled to pultrusion equipment to continuously pull the inserts through the die 30 during the extrusion process of the extruded window profile 10. It will be appreciated that other conventional push or pulling techniques may be utilized to continuously feed the inserts 20 through the die 30 during the extrusion process.

As shown in FIG. 3, the front insert slots 34 are adjacent to selected locations of the profile extrusion chamber 35. As a result, the extruded profile 10 emerges from the profile extrusion chamber 35 together with the inserts 20 passing through the front inserts slots 34 so that the extruded profile 10 includes the inserts 20 integrated in the extruded profile 10.

In certain embodiments, aluminum strip inserts 20 are pre-coated on some or all surfaces with a heat-activated adhesive. Such adhesives are known from use in the automobile industry. However, in the automobile industry the adhesive is used with stiffening elements where the metal is used as the profile, as opposed to the invention's window profile preferably being composed of rigid PVC, and softer, flexible vinyl or plastic material (not rigid PVC) being extruded to bond with the metal profile to make items such as window and door seals.

Advantageously in embodiments of the invention, a heat-activated adhesive pre-applied to the metal insert 20, such as aluminum strips, provides a continuous bond along the entire surface of the metal insert 20. The adhesive used in the extrusion process of embodiments of the invention creates a bond between the PVC of the profile 10 and metal insert 20 that avoids the occurrence of shearing.

In some embodiments infrared (IR) heating can be applied to some or all of the surface of an aluminum strip insert 20 pre-coated with adhesive prior to extruding the PVC. Preferably heat is applied just at the surface to activate the adhesive but not heat the whole aluminum throughout the insert 20 and have negative effect on the rigid PVC profile (such as by requiring to cool the PVC profile since whole aluminum would otherwise be hot).

In addition to or as an alternative to IR surface heating (to just heat a surface of the metal), heat may be applied in a broad range of from 24 degrees Celsius to 190 degrees Celsius to heat metal inserts 20, such as aluminum strips, and still get a bonding effect of the metal insert 20 to the cellular and/or non-cellular rigid PVC of the profile 10. In the prior art, such as automotive industry techniques with flexible vinyl/plastic and pre-treated metal profiles that may include adhesive, it is typically recommended that heating of the metal profile is from 160-190 degrees Celsius. Our discovery of lower temperature heating of aluminum inserts 20 to co-extrude with rigid PVC, as well as IR surface-focused heating, are both advantages of the invention's different use of metal elements as stiffening elements within rigid PVC, and particularly in window profiles, in comparison to the prior art techniques intended for different purposes.

In some embodiments of the invention, metal inserts 20 are aluminum elements that may be flat. In some embodiments metal inserts 20 are flat and in the form of strips that may be provided on coils and then fed through die 30 during the extrusion process. In other embodiments metal inserts 20 may be shaped. In further embodiments flat and shaped aluminum inserts 20 may both be used in the same extrusion.

In embodiments, the die temperature of the PVC for co-extrusion with the metal insert 20 is typically 170-180 degrees Celsius (with melt temp of PVC of 170-190 degrees Celsius).

In embodiments, the line speed for the extrusion process, including the feeding of inserts through an extrusion die, may be at least 40 inch/min . In some embodiments the line speed may be from about 40 inch/min and up to about 120 inch/min and even higher. Preferably, about 40 inch/min is a low-end parameter since running slower would likely not provide competitive manufacturing speed.

In some embodiments, where the insert 20 is a flat metal aluminum insert, although not limited to flat or aluminum in other embodiments, may be from about 0.012-0.120 inches thick. In preferred embodiments a flat insert 20 utilized may be about 0.032 inches thick. In other embodiments a considerably thicker insert 20 to provide further stiffening may be about 0.064 inches thick. It will be appreciated that thickness of the insert 20 may be adjusted to the particular application of the co-extruded profile and desired function of the insert 20.

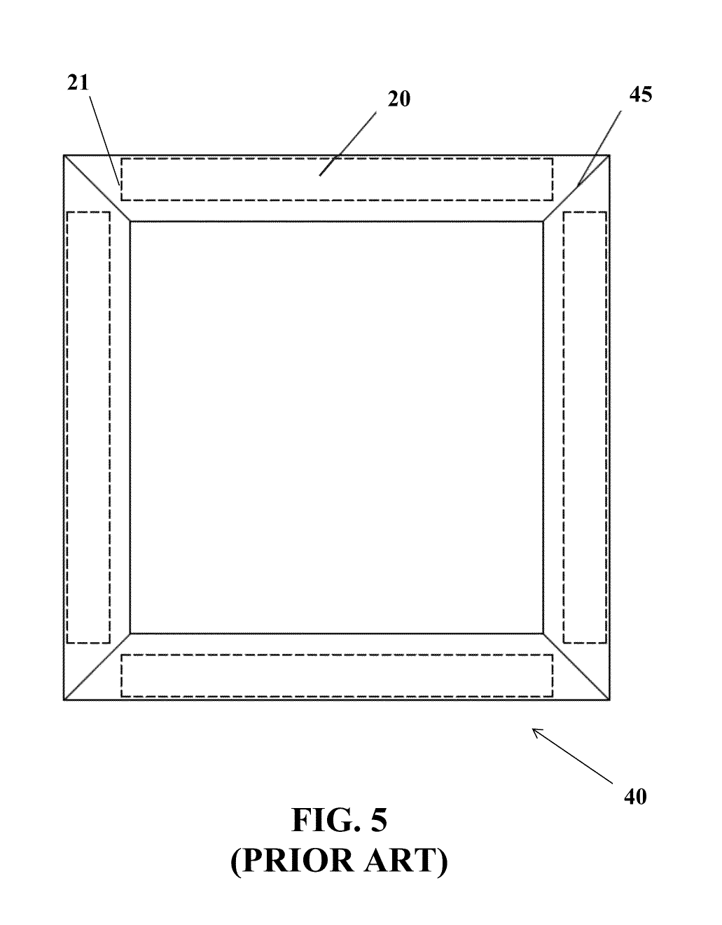

Referring to FIGS. 5 (prior art) and 6, embodiments of the present invention are advantageous to structural reinforcement of assembled window frames including extruded window profiles 10 with reinforcement inserts 20 (shown by dashed lines) having been co-extruded with the window profile 10. In current manufacturing practice, the ends 21 of the inserted reinforcement are straight cut before insertion into the PVC extrusions and welding of the mitered corners 45 of the PVC extrusions. The inserted reinforcement 20 does not extend to the corners 45 of the window sash or frame 40. As shown in FIG. 5, in prior art reinforced window practices an insert 20 is cut to form straight insert edge ends 21 that do not extend to reach the mitered corners 45. As a result, the reinforcement by inserts 20 is discontinuous at the corners 45 in such prior art frames 40.

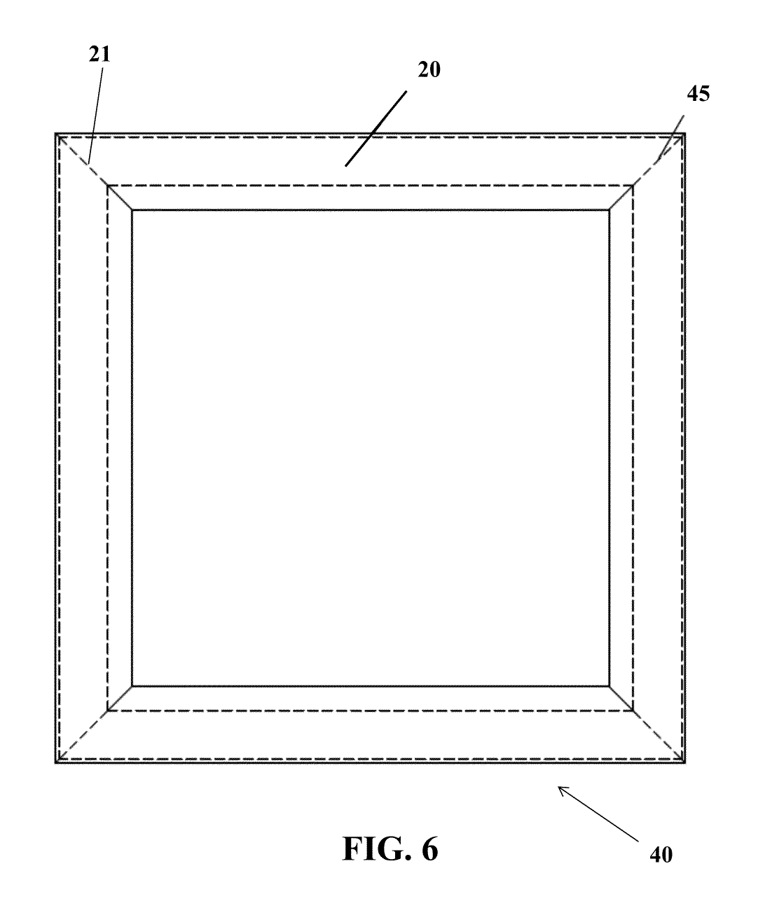

With reference to FIG. 6, in an embodiment of the present invention, an aluminum strip insert 20 (shown by dashed lines) is cut at an end 21 with the same angle as the end of the respective extruded PVC window profile 10 that includes the insert 20. The insert 20 extends completely to the mitered corners 45 of the finished window sash or frame 40. As a result, the reinforcement at the corners 45 of a window sash or frame 40 is advantageously able to remain continuous.

While the invention has been described with reference to exemplary structures and methods in embodiments, the invention is not intended to be limited thereto, but to extend to modifications and improvements within the scope of equivalence of such claims to the invention.

What is claimed is:

1. An extruded window profile including a plurality of separate and integrated metal inserts within the entire length of the extruded window profile.

2. The profile of claim 1, wherein one or more of the inserts are bound by an adhesive to surrounding polyvinylchloride.

3. The profile of claim 2, wherein one or more of the inserts are aluminum.

4. The profile of claim 1, wherein one or more of the inserts are aluminum.

5. The profile of claim 4, wherein the profile comprises rigid polyvinylchloride.

6. The profile of claim 1, wherein the profile comprises rigid polyvinylchloride.

7. The profile of claim 2, wherein the profile comprises rigid polyvinylchloride.

8. The profile of claim 7 wherein the adhesive is heat-activated.

8. The profile of claim 3, wherein the adhesive is heat-activated.

9. The profile of claim 2, wherein the adhesive is heat activated.

10. A method of manufacturing an extruded window profile comprising extruding polyvinylchloride through a window profile extrusion die while continuously feeding one or more adhesive-coated aluminum reinforcing inserts through the die and in the surrounding polyvinylchloride that forms the outer surface of the extruded window profile.

11. The method of claim 10, wherein one or more aluminum inserts are flat.

12. The method of claim 11, further comprising feeding one or more aluminum inserts from a coil.

13. The method of claim 10, wherein the adhesive is heat-activated.

14. The method of claim 13, wherein some or all of an adhesive-coated surface of a reinforcing insert is heated prior to being fed through the die without fully heating the entirety of the reinforcing insert.

15. The method of claim 11, wherein the adhesive is heat-activated.

16. The method of claim 15, wherein some or all of an adhesive-coated surface of a reinforcing insert is heated prior to being fed through the die without fully heating the entirety of the reinforcing insert.

17. The method of claim 16, further comprising heating the aluminum reinforcing insert that is being heated in the range of from about 24 degrees Celsius to about 190 degrees Celsius prior to being fed through the die.

18. The method of claim 16, further comprising feeding the one or more inserts through the die at a speed of at least 40 inch/min.

19. The method of claim 16, further comprising heating the extrusion die in the range of from about 160 degrees Celsius to about 190 degrees Celsius.

20. A window sash or frame comprising a continuously reinforced corner including mitered ends of adjacent extruded window profiles that each include a metal reinforcement insert with an end cut at a same angle as a mitered end of an insert's respective extruded window profile.
